(19) United States
(12) Patent Application Publication
(10) Pub. No.: US 2013/0173897 A1
(43) Pub. Date: Jul. 4, 2013

(54) COMPUTER SYSTEM

(71) Applicant: Hao-Hao Wang, Shanghai City (CN)

(72) Inventor: Hao-Hao Wang, Shanghai City (CN)

(73) Assignee: INVENTEC CORPORATION, Taipei City (TW)

(21) Appl. No.: 13/397,072

(22) Filed: Feb. 15, 2012

(30) Foreign Application Priority Data
Dec. 29, 2011 (CN) 201110452816.4

(51) Int. Cl. G06F 15/177

(52) U.S. Cl. 713/1

(57) ABSTRACT

A computer system including a configuration unit and a plurality of computers is provided. The configuration unit sends login information and key information to a basic input/output system (BIOS) setting unit in each of the computers to simultaneously configure and check the BIOS settings of the computers.

### CROSS-REFERENCE TO RELATED APPLICATION

This application claims the priority benefit of China application serial no. 201110452816.4, filed on Dec. 29, 2011. The entirety of the above-mentioned patent application is hereby incorporated by reference herein and made a part of this specification.

### BACKGROUND OF THE INVENTION

1. Field of the Invention

The invention generally relates to a computer system, and more particularly, to a computer system which can simultaneously configure and check the basic input/output system (BIOS) settings of a plurality of computers.

2. Description of Related Art

A basic input/output system (BIOS) is a program stored in a read-only memory (ROM) and which retains when the ROM is not powered. A BIOS defines a set of routine operation instructions and works closely with hardware to support data transmission between specific components (for example, a memory, a floppy/hard disc, and a display) of a computer system. In a new-generation main board, the BIOS program is usually burnt in a flash erasable programmable ROM (flash EPROM) so that later on it can be conveniently modified and debugged.

Each computer system has its own BIOS on the main board of the computer system. When the computer system is turned on, the central processing unit (CPU) on the main board loads the BIOS and related set-up values and then executes a booting program according to the set-up values. If a user wants to modify a set-up value (for example, the user wants to change the boot sequence to “hard disk, CD-ROM, and network device”, or “CD-ROM, hard disk, and universal serial bus (USB) device”), the user needs to enter the BIOS to modify the set-up value.

Generally speaking, to modify the BIOS, a BIOS interface is manually opened and a submenu is entered through the keyboard (for example, the up and down arrow keys and the enter key) to modify each option in the submenu. Because such a modification operation is done manually and each time can only be performed on one computer, it will be too time- and labor-consuming if a user (for example, a computer manufacturer) wants to adjust or inspect many computers.

### SUMMARY OF THE INVENTION

Accordingly, the invention is directed to a computer system which can simultaneously configure and check the basic input/output system (BIOS) settings of a plurality of computers.

The invention provides a computer system including a plurality of computers and a configuration unit. Each of the computers includes a BIOS unit and a BIOS setting unit. The BIOS setting unit has configuration information of the corresponding BIOS unit and computer, wherein the configuration information is corresponding to a setting interface, and the setting interface includes a plurality of setting options. The configuration unit is communicatively connected with the BIOS setting units of the computers. The configuration unit sends a login information to the BIOS setting units to log into the setting interfaces, sends a key information to the BIOS setting units to select the setting options, and sends a key information to the BIOS setting units to set set-up values of the setting options.

According to an embodiment of the invention, the BIOS setting units are respectively connected to a serial port, and the configuration unit sends the key information to the BIOS setting units via the serial ports.

The invention provides a computer system including a plurality of computers and a configuration unit. Each of the computers includes a BIOS unit and a BIOS setting unit. The BIOS setting unit has configuration information of the corresponding BIOS unit and computer, wherein the configuration information is corresponding to a setting interface, and the setting interface includes a plurality of setting options. The configuration unit is communicatively connected with the BIOS setting units of the computers. The configuration unit sends a login information to the BIOS setting units to log into the setting interfaces, sends a key information to the BIOS setting units to select the setting options, and reads set-up values of the setting options.

According to an embodiment of the invention, the BIOS setting units are respectively connected to a serial port, and the configuration unit sends the key information to the BIOS setting units and reads the set-up values of the setting options via the serial ports.

According to an embodiment of the invention, the computers respectively include a baseboard management controller. The BIOS setting units respectively communicate with the baseboard management controllers via a serial port circuit. The baseboard management controllers are connected with the configuration unit through a network. The configuration unit sends network signals containing key information to the baseboard management controllers via the network. The baseboard management controllers convert the network signals into serial port signals and send the serial port signals to the BIOS setting units. Set-up value information of the setting options of the BIOS setting units is sent to the baseboard management controllers via the serial port circuits. The baseboard management controllers convert the serial port signals into network signals and send the network signals to the configuration unit.

According to an embodiment of the invention, the configuration unit has a BIOS preconfigured version information related to the key information. After the configuration unit sends the login information to the BIOS setting units to log into the setting interfaces, the configuration unit determines whether version information of the BIOS units stored in the BIOS setting units matches the BIOS preconfigured version information. When the version information of the BIOS units matches the BIOS preconfigured version information, the configuration unit continues to perform subsequent operations. When the version information of the BIOS units does not match the BIOS preconfigured version information, the configuration unit stops sending information to the BIOS setting units which store the unmatched version information and issues a prompt information.

According to an embodiment of the invention, the configuration unit has a standard configuration information. The configuration unit compares the set-up value information of each of the setting options of each of the BIOS setting units with the standard configuration information and generates a report.

According to an embodiment of the invention, after the configuration unit sends the key information to the BIOS setting units to select the setting options, the configuration unit determines whether the correct setting option is selected according to a description information sent back by the selected setting option. When the correct setting option is selected, the configuration unit continues to perform subsequent operations. When the correct setting option is not selected, the configuration unit sends a key information to exit the setting interface and login again and tries to select the correct setting option again. When the configuration unit tries more than a predetermined number N of times, the configuration unit stops sending information to the BIOS setting unit and prompts an error.

As described above, in the invention, a configuration unit sends login information and key information to the BIOS setting units to simultaneously configure and check the BIOS settings of a plurality of computers.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a computer system according to an embodiment of the invention.

FIG. 2 is a diagram of a computer system according to another embodiment of the invention.

FIG. 3 is a flowchart of a method of configuring the BIOS settings of each computer in a computer system according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

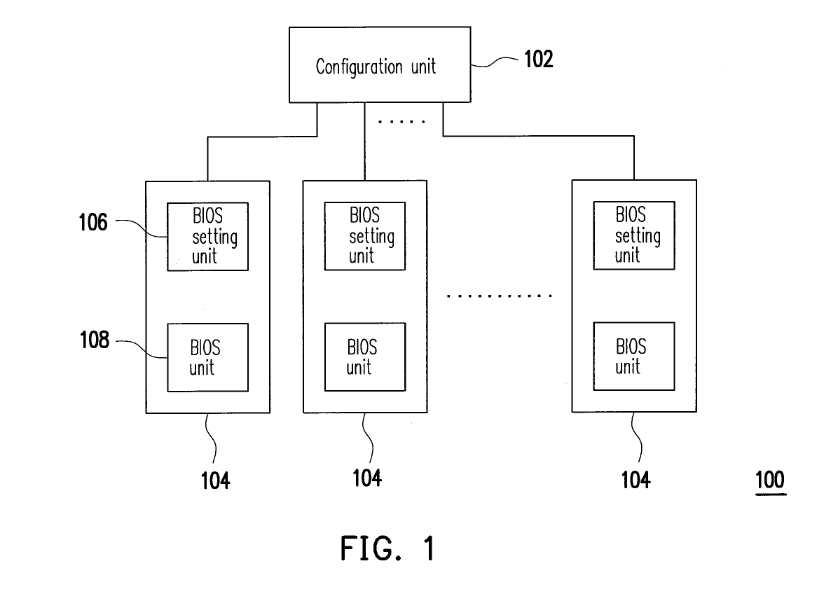

FIG. 1 is a diagram of a computer system according to an embodiment of the invention. Referring to FIG. 1, the computer system 100 includes a configuration unit 102 and a plurality of computers 104 connected with the configuration unit 102. Each of the computers 104 includes a basic input/output system (BIOS) setting unit 106 and a BIOS unit 108. The BIOS setting unit 106 has configuration information of the corresponding BIOS unit 108 and computers 104, wherein the configuration information is corresponding to a setting interface, and the setting interface includes a plurality of setting options (for example, whether each hardware or peripheral device is in use, the device number of each hardware or peripheral device, boot sequence, and the operation frequency of the central processing unit (CPU)).

The configuration unit 102 communicates with the BIOS setting units 106 of the computers 104. For example, the configuration unit 102 sends a login information to the BIOS setting units 106 to log into the setting interfaces and sends key information (for example, the up, down, left, and right arrow keys) to the BIOS setting units 106 to select the setting options. To be specific, the BIOS setting units 106 are respectively connected to a serial port (not shown). The configuration unit 102 sends the key information to the BIOS setting units 106 via the serial ports. In addition, the configuration unit 102 also sends key information (for example, the enter key or a set-up value) to the BIOS setting units 106 to configure the set-up values of the setting options. Moreover, after the settings are done, the configuration unit 102 further sends key information (for example, the ESC key) to exit the selected setting option or the setting interfaces.

The configuration unit 102 has a BIOS preconfigured version information related to the key information it sends. After the configuration unit 102 sends a login information to the BIOS setting units 106 to log into the setting interfaces, it determines whether the version information of the BIOS units 108 stored in the BIOS setting units 106 matches the BIOS preconfigured version information. If the version information of the BIOS units 108 matches the BIOS preconfigured version information, the configuration unit 102 continues to perform subsequent operations (i.e., continues to select and configure the setting options). If the version information of the BIOS units 108 does not match the BIOS preconfigured version information, the configuration unit 102 stops sending information to the BIOS setting units 106 which store the unmatched version information and issues a prompt information to inform a user about the computer having the BIOS preconfigured version information.

Additionally, after the configuration unit 102 sends a key information to the BIOS setting units 106 to select the setting options, it determines whether the correct setting option is selected according to a description information sent back by the selected setting option. If the correct setting option is selected, the configuration unit 102 continues to perform subsequent operations (for example, configure the set-up value of the selected setting option). Contrarily, if the correct setting option is not selected, the configuration unit 102 sends a key information to exit and log into the setting interfaces and tries to select the correct setting option again. The configuration unit 102 repeats foregoing operation until the number of times it tries is greater than a set-up value N (N is a positive integer), and then the configuration unit 102 stops sending information to the BIOS setting units 106 and prompts an error.

As described above, because the configuration unit 102 is corresponding to multiple computers 104, the BIOS of these computers 104 can be simultaneously configured without manually adjusting the settings of the computers 104 one by one. All the computers 104 can be set up at the same time through the configuration unit 102, and all the operations (including logging into the BIOS interface, modifying the set-up values, and exiting and restarting the system) can be automatically performed. Thus, both labor and time costs are greatly reduced.

It should be noted that in the embodiment described above, besides configuring the BIOS by sending different information to the BIOS setting units 106, the configuration unit 102 may also read set-up values of the setting options through the BIOS setting units 106 to understand the states of the computers 104. For example, in some embodiments, the configuration unit 102 has a standard configuration information. The configuration unit 102 compares the set-up value information of each setting option of each BIOS setting unit 106 with the standard configuration information and generates a report such that a user can understand the difference between the BIOS settings of each computer 104 and the standard configuration information. Accordingly, the user needs not to manually check the BIOS settings of the computers 104 one by one, so that the user can set up and adjust the computers 104 very efficiently.

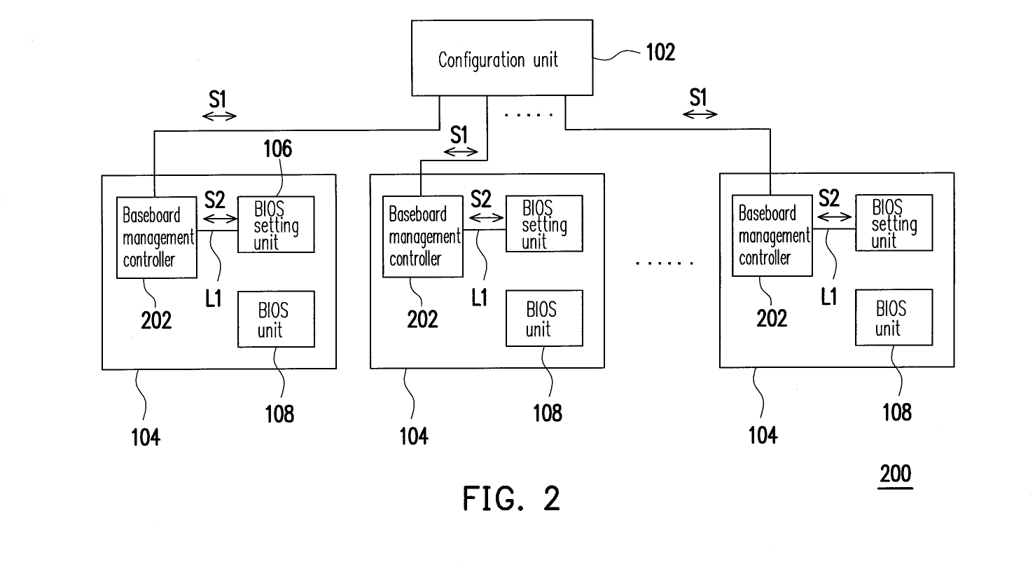

FIG. 2 is a diagram of a computer system according to another embodiment of the invention. Referring to FIG. 2, the difference between the computer system 200 and the computer system 100 in FIG. 1 is that each computer 104 in the computer system 200 further includes a baseboard management controller 202. The BIOS setting unit 106 of each computer 104 communicates with the baseboard management controller 202 via a serial port circuit L1, and the baseboard management controller 202 is connected with the configuration unit 102 through a network. The configuration unit 102 sends network signals S1 (for example, serial over LAN (SOL)) containing key information to the baseboard management controllers 202 via the network, and the baseboard management controllers 202 convert the network signals 51 into serial port signals S2 and send the serial port signals S2 to the BIOS setting units 106.

In addition, the set-up value information of the setting options in the BIOS setting units 106 may also be sent to the baseboard management controllers 202 via the serial port circuit L1, and the baseboard management controllers 202 may convert the serial port signals S2 into the network signals S1 and send the network signals S1 to the configuration unit 102. As described above, the transmission of the login information and the key information between the configuration unit 102 and the BIOS setting units 106 may be completed through the baseboard management controllers 202. The only difference between the embodiment illustrated in FIG. 2 and the embodiment illustrated in FIG. 1 falls on whether aforementioned information is transmitted via the baseboard management controllers 202, the configuration and inspection of the BIOS settings in the embodiment illustrated in FIG. 2 are the same as those in the embodiment illustrated in FIG. 1 therefore will not be described herein.

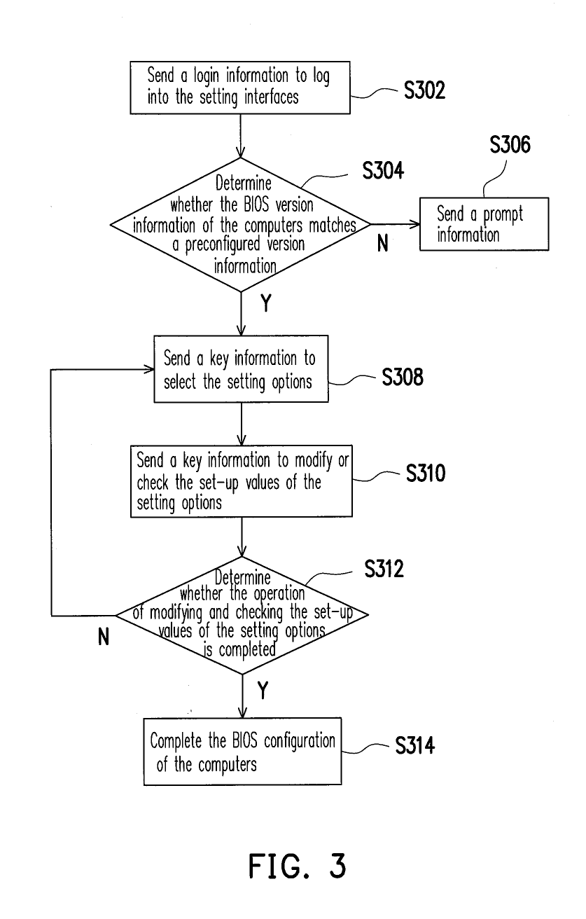

FIG. 3 is a flowchart of a method of configuring the BIOS settings of each computer in a computer system according to an embodiment of the invention. Referring to FIG. 3, the method in the present embodiment includes following steps. First, a login information is sent to log into the setting interfaces (step S302). Then, whether the BIOS version information of the computers matches a preconfigured version information is determined (step S304). If the BIOS version information of the computers does not match the preconfigured version information, a prompt information is sent (step S306). If the BIOS version information of the computers matches the preconfigured version information, a key information is sent to select the setting options (step S308). Next, a key information is sent to modify or check the set-up values of the setting options (step S310). After that, whether the operation of modifying and checking the set-up values of the setting options is completed is determined (step S312). If the operation of modifying and checking the set-up values of the setting options is not completed yet, step 308 is executed again to continue sending the key information and selecting the setting options. If the operation of modifying and checking the set-up values of the setting options is completed, the BIOS configuration of the computers is completed (step S314).

As described above, in the invention, login information and key information is sent to each BIOS setting unit via a configuration unit, so that the BIOS settings of multiple computers can be simultaneously configured and checked and the BIOS itself needs not to be modified. Accordingly, both labor and time costs can be greatly reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A computer system, comprising:
a plurality of computers, wherein each of the computers comprises:
a basic input/output system (BIOS) unit; and
a BIOS setting unit, having configuration information of the corresponding BIOS unit and the corresponding computer, wherein the configuration information is corresponding to a setting interface, and the setting interface comprises a plurality of setting options;
a configuration unit, communicatively connected with the BIOS setting units of the computers, sending a login information to the BIOS setting units to log into the setting interfaces, sending a key information to the BIOS setting units to select the setting options, and sending a key information to the BIOS setting units to set set-up values of the setting options.

2. The computer system according to claim 1, wherein the BIOS setting units are respectively connected to a serial port, and the configuration unit sends the key information to the BIOS setting units via the serial ports.

3. The computer system according to claim 1, wherein the computers respectively comprises a baseboard management controller, the BIOS setting units respectively communicate with the baseboard management controllers via a serial port circuit, the baseboard management controllers are connected with the configuration unit through a network, the configuration unit sends network signals containing key information to the baseboard management controllers via the network, and the baseboard management controllers convert the network signals into serial port signals and send the serial port signals to the BIOS setting units.

4. The computer system according to claim 1, wherein the configuration unit has a BIOS preconfigured version information related to the key information, and after the configuration unit sends the login information to the BIOS setting units to log into the setting interfaces, the configuration unit determines whether version information of the BIOS units stored in the BIOS setting units matches the BIOS preconfigured version information, wherein when the version information of the BIOS units matches the BIOS preconfigured version information, the configuration unit continues to perform subsequent operations, and when the version information of the BIOS units does not match the BIOS preconfigured version information, the configuration unit stops sending information to the BIOS setting units which store the unmatched version information and issues a prompt information.

5. The computer system according to claim 1, wherein after the configuration unit sends the key information to the BIOS setting units to select the setting options, the configuration unit determines whether the correct setting option is selected according to a description information sent back by the selected setting option,
wherein when the correct setting option is selected, the configuration unit continues to perform subsequent operations;
when the correct setting option is not selected, the configuration unit sends a key information to exit the setting interface and login again and tries to select the correct setting option again, and when the configuration unit tries more than a predetermined number N of times, the configuration unit stops sending information to the BIOS setting unit and prompts an error, wherein N is a positive integer.

6. A computer system, comprising:
a plurality of computers, wherein each of the computers comprises:
a BIOS unit; and
a BIOS setting unit, having configuration information of the corresponding BIOS unit and the corresponding computer, wherein the configuration information is corresponding to a setting interface, and the setting interface comprises a plurality of setting options;
a configuration unit, communicatively connected with the BIOS setting units of the computers, sending a login information to the BIOS setting units to log into the setting interfaces, sending a key information to the BIOS setting units to select the setting options, and reading set-up values of the setting options.

7. The computer system according to claim 6, wherein the BIOS setting units are respectively connected to a serial port, and the configuration unit sends the key information to the BIOS setting units and reads the set-up values of the setting options via the serial ports.

8. The computer system according to claim 6, wherein the computers respectively comprise a baseboard management controller, the BIOS setting units respectively communicate with the baseboard management controllers via a serial port circuit, the baseboard management controllers are connected with the configuration unit through a network, the configuration unit sends network signals containing key information to the baseboard management controllers via the network, the baseboard management controllers convert the network signals into serial port signals and send the serial port signals to the BIOS setting units, set-up value information of the setting options of the BIOS setting units is sent to the baseboard management controllers via the serial port circuits, and the baseboard management controllers convert the serial port signals into network signals and send the network signals to the configuration unit.

9. The computer system according to claim 6, wherein the configuration unit has a BIOS preconfigured version information related to the key information, and after the configuration unit sends the login information to the BIOS setting units to log into the setting interfaces, the configuration unit determines whether version information of the BIOS units stored in the BIOS setting units matches the BIOS preconfigured version information, wherein when the version information of the BIOS units matches the BIOS preconfigured version information, the configuration unit continues to perform subsequent operations, and when the version information of the BIOS units does not match the BIOS preconfigured version information, the configuration unit stops sending information to the BIOS setting units which store the unmatched version information and issues a prompt information.

10. The computer system according to claim 6, wherein the configuration unit has a standard configuration information, and the configuration unit compares the set-up value information of each of the setting options of each of the BIOS setting units with the standard configuration information and generates a report.

11. The computer system according to claim 6, wherein after the configuration unit sends the key information to the BIOS setting units to select the setting options, the configuration unit determines whether the correct setting option is selected according to a description information sent back by the selected setting option,
wherein when the correct setting option is selected, the configuration unit continues to perform subsequent operations;
when the correct setting option is not selected, the configuration unit sends a key information to exit the setting interface and login again and tries to select the correct setting option again, and when the configuration unit tries more than a predetermined number N of times, the configuration unit stops sending information to the BIOS setting unit and prompts an error, wherein N is a positive integer.
